(19) United States
(12) Patent Application Publication
(10) Pub. No.: US 2004/0009801 A1
(43) Pub. Date: Jan. 15, 2004

(54) Indian poker casino game

(76) Inventor: Dinh Duc Nama, Westminster, CA (US)

Correspondence Address: DINH DUC NAMA, 10512 Bolsa Ave #202, Westminster, CA, 92683, US

(21) Appl. No.: 10/193,343

(22) Filed: Jul. 12, 2002

(51) Int. Cl. A63F 13/00

(52) U.S. Cl. 463/13

(57) ABSTRACT

The method of playing a card game according to the present invention is operated among multi-players, a Dealer and a Banker. The game is played with 15 decks of cards from J to A and 1 Joker from each deck, hence there are 255 cards altogether. All cards from 2 to 10 are removed. Or the game is played with 2 decks of cards from J to A hence there are 32 cards plus 3 Jokers total 35 cards altogether. All cards from 2 to 10 are removed. According the method of the present invention, each player places a wager before the Banker shakes the Dice Cup which contains 3 dices to determine where the action starts. The Dealer will deliver 3 cards unexposed to each player. The players set their hands by making a one card hand and a two card hand. The two card hand must rank higher than one card hand. After all players have set their hands, the Dealer will then reveal the Banker's cards the way the Banker wants them to be set. Then the Dealer will compare the cards of each player to the Banker's cards and winners or losers or pushers are determined based on the comparison.

### CROSS-REFERENCE TO RELATED APPLICATIONS

Not applicable.

### BACKGROUND

1. Field of Invention

This invention relates to card gambling games to be used in casinos.

2. Description of Prior Art

Presently, there are several card games for multi-players being used in a casino-type environment. All of these card games compared whether the dealer's hands are better than the player's hands and win or lose a specific amount based on the wagering bet.

U.S. Pat. No. 4,659,087 issued to Margaret Shen et al. on Apr. 21, 1987 discloses a Casino Game involving the play of two groups of two cards each with the object being for each of a player's pairs to have a higher value than the two pairs of the dealer.

U.S. Pat. No. 5,154,429 issued to Richard A. LaVasseur on Oct. 13, 1992 discloses a Method Of Playing Multiple Action Blackjack and discloses a semicircular playing surface with the rules of play being similar to Twenty One or Blackjack. Here the cards of the player are compared to the cards of the dealer; whoever get closed to 21 without going over will win.

None of these games, however, use modified card decks in combination with customized playing rules, as does the present invention.

### SUMMARY OF THE INVENTION

The method of playing a card game according to the present invention is operated among multi-players, a Dealer and a Banker. Each player who has wagered on a spot the previous hand has the option to be the Banker there on the next hand. The game is played with 15 decks of cards from J to A and 1 Joker from each deck, hence there are 255 cards altogether. All cards from 2 to 10 are removed. Or the game is played with 2 decks of cards from J to A, hence there are 32 cards altogether. All cards from 2 to 10 are removed. According to the method of the present invention, each player places a wager before the Banker shakes the Dice Cup which contains 3 dices. Once the Dealer has released the dice and announced “no more bets”, no player may change his wager. The Dealer will deliver 3 cards unexposed to each player. The players set their hands by making a one card hand and a two card hand. The two card hand must rank higher than the one card hand. Players then lay both hands face down in the squares on the table, unexposed. After all players have set their hands, the Dealer will then reveal the Banker's cards the way the Banker wants them to be set. Then the Dealer will compare the cards of each player to the Banker's cards and winners or losers or pushers are determined based on the comparison.

### BRIEF DESCRIPTION OF THE DRAWINGS

The present invention, both as to its organization and manner of operation, may best be understood by reference to the following description, taken in connection with the accompanying drawings.

FIG. 1 shows examples of some possible combinations of players' cards of the present invention.

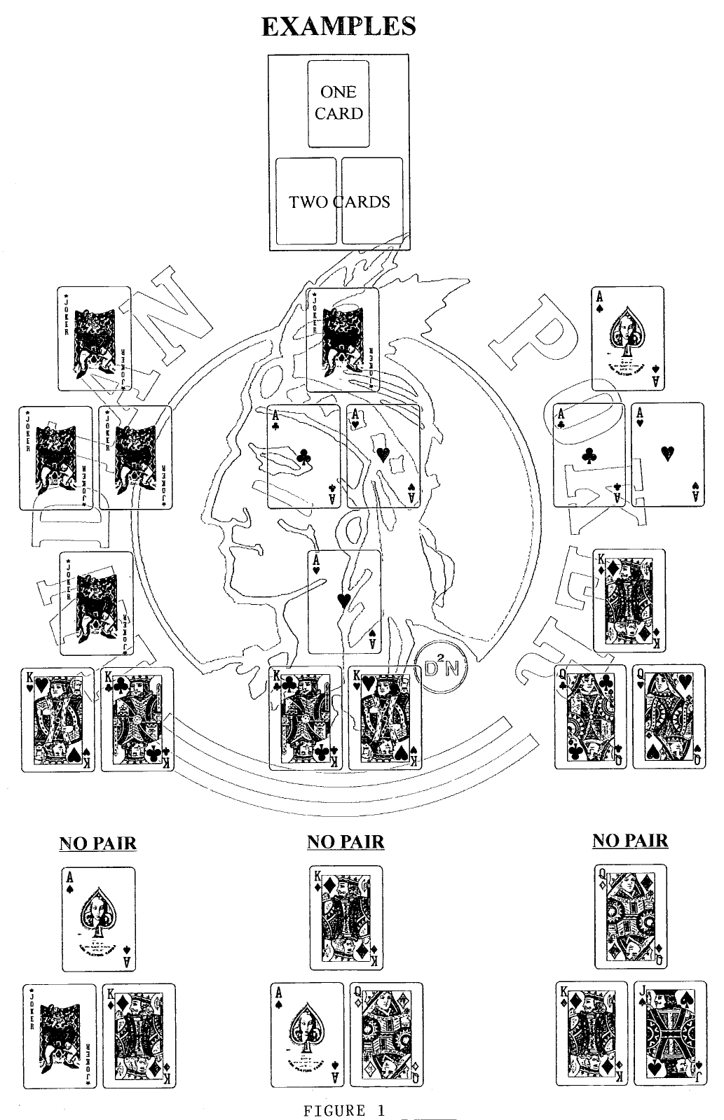

FIG. 2 shows the Hand Rankings chart of the present invention which shows all the possible rankings that the players can have.

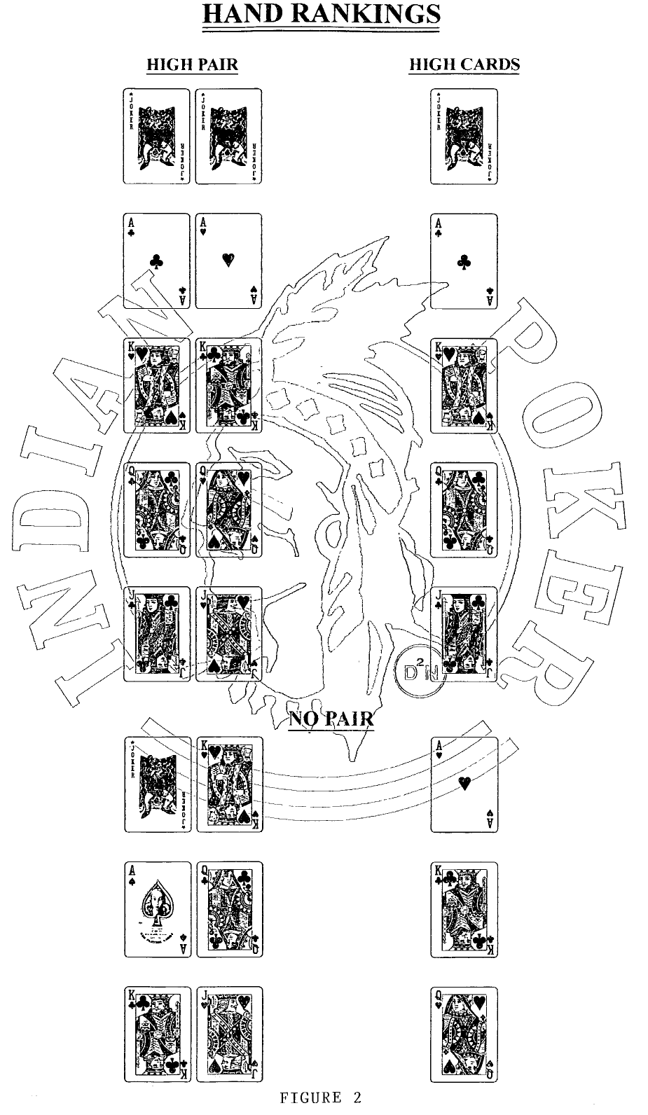

### DESCRIPTION OF THE PREFERRED EMBODIMENTS

The following description of rules is provided to enable any person skilled in the art to make and use the invention.

1. The Club does not take part in the play of the game and has no interest in the result of the play. No player plays against or makes a wager against the Club.

2. A player must have a full minimum bet after paying collection, which will be taken before each bet.

3. Each table has a spread limit to define the maximum and minimum amounts to be wagered in each spot.

4. A player must bet at least the table minimum. Less than minimum bets will receive action, but will not be tolerated.

5. No action will be received by any amount that is bigger than the maximum table limit.

6. Banker wagers are not limited by maximum.

7. Action starts with action button and goes clockwise.

8. Only chips are used in paying off bets.

9. The player that controls the seat is considered as the active player for that spot and only he may handle the cards.

10. No more than 2 backlines bets are allowed on each spot.

11. The active player may refuse backline bets but if he is not wagering on that spot he may not prohibit other player from wagering on it. Once a player has wagered on a spot, he is allowed to wager or backline there until the Banker position goes to the next player. Backline players may participate in the play of the hand.

12. When there is a disagreement over the play of the hand between the player and the backline, final decision will be made by the player with largest wager. When the largest wagers are of equal amount, the active player makes the decision.

13. If the backline player wishes to make a decision on the hand, he must have the largest bet and must verbally declare his intention to the Dealer to stop the action before the active player acts.

14. In the Banker position, the largest wager in action makes the final decision in any disagreement on the play of the hand.

15. The Banker shakes the Dice Cup (containing three (3) dices) to determine where the action starts. The Banker position is always 1, 9, or 17; numbers count clockwise. EXAMPLE: Dice read 2, 3, 5 for a total of 10; in this case action would begin one position to the left of the Banker.

16. Once the Dealer has released the dice and announced “no more bets” no player may change his wager. Anyone who violates will possibly forfeit his wager to the extent that money covers or may be barred from playing and subject to prosecution as penalty.

17. All players must put their entire wager in the spot before the Dealer releases the dice. Only chips are in the spot plays. No stating money cover or call bets is accepted.

18. An active player is entitled to ask the Dealer about the amount of the Banker's wager that he thinks may affects the play of his hand.

19. No side bets or proposition bets are allowed.

20. A player who has wagered on a spot the previous hand has the option to be the Banker there on the next hand. If a player had no wager the previous hand, he may not be the Banker on that spot.

21. A player who has put in chips for a bet may not back out after the Dealer announced “no more bets”.

22. Passing, switching and holding out cards are strictly forbidden and can cause a hand to be foul and the forfeiture of that wager to the extent that money covers. Any player who is found guilty of such attempts will be barred from the play and may be subject to prosecution.

23. No player may remove a losing bet.

24. A player who removes a winning bet from the betting circle may be paid the minimum bet only.

25. If the one card hand ranks higher than the two-card hand the hand is “Foul Hand” and a player who has his hand dropped below the table level and a wrong number of cards may be considered as having a Foul Hand too, and wager will be collected and paid to the Banker immediately.

26. No showing or discussing of hands among players is allowed.

27. A player may see only one hand, even if he has wagered on several hands.

28. INDIAN POKER is played on a crescent table with 8 spots or hands from #1 to #8.

29. The game is played with 15 decks of cards from J to A and 1 Joker from each deck, hence there are 255 cards altogether. All cards from 2 to 10 are removed. Or the game is played with 2 decks of cards from J to A hence there are 32 cards plus 3 Jokers total 35 cards altogether. All cards from 2 to 10 are removed.

30. Joker is the highest card.

31. Each hand acts the Banker twice: 1^{st} Banker and 2^{nd} Banker.

32. Hand #1 acts the Banker first. If hand #1 does not have the minimum amount of money as set to act the Banker or does not want to act the Banker hand #2 will replace him/her and so on.

33. Dice number will determine where the action starts.

34. As the game is played with 8 hands, number 1, 9 and 17 always fall on the Banker.

35. The Dealer will deliver 3 cards unexposed to each hand.

36. Players are allowed to pick up and see the 3 cards just delivered to them. The players set their hands by making a one (1) card hand a two (2) card hand. The two (2) card hands must rank higher than the one (1) card hand. Players then lay both hands face down in the squares on the table, exposed.

37. The “Dealer” button is placed on the Banker's cards which are opened only after all players have “set” their hand, when the Dealer sees that all player's cards are down, he will announce “all hands are set,” at which time the players may not touch their cards for remainder of the hand. The Dealer will then reveal the Banker's cards the two (2) hands the way the Banker wants them to be set.

38. Then the Dealer will expose all the 3 cards of each hand for comparison.

39. The player's cards are revealed starting from the action button and compared in turn to the Banker's hands. In order for the player to win, both the one (1) card hand (front hand) and two (2) card hand (back hand) must beat the Banker's both hands. If the Banker's one (1) card and two (2) card hand beat the player's both hands, then the wager is collected and paid to the Banker. If one hand wins and one loses, it is a push (tie). If one hand copies (copy hand) and one wins, it is a win. If one hand copies (copy hand) and one loses, it is a

1. The method of playing a card game among multi-players, a house Dealer and a Banker, the method comprising the following steps:
a. The game is played with 15 decks of conventional 52-card deck being modified by:
Only cards from J to A and 1 Joker from each deck are used, hence there are 255 cards altogether.
All cards from 2 to 10 are removed.
b. Or the game is played with 2 decks of conventional 52-card deck being modified by:
Only cards from J to A and 1 Joker are used, hence there are 32 cards plus 3 Jokers total 35 cards altogether.
All cards from 2 to 10 are removed.
c. Each of the players is placing a wager ranging from the table minimum and table maximum.
d. Banker wagers are not limited by maximum.
e. Only chips are used in paying off bets.
f. The Banker shakes the Dice Cup (containing three dices) to determine where the action starts.
g. The Banker position is always 1, 9, or 17; numbers count clockwise.
h. A player who has wagered on a spot the previous hand has the option to be the Banker there on the next hand. If a player had no wager the previous hand, he may not be the Banker on that spot.
i. The Dealer will deliver 3 cards unexposed to each hand.
j. Each of the players set their hands by making a one (1) card hand a two (2) card hand. The two (2) card hands must rank higher than the one (1) card hand.
k. The Dealer will reveal the Banker's cards and arrange the two hands the way the Banker wants them to be set.
l. The Dealer will determine if each of the players' hands should win over the hands of the Banker.

2. The method of playing a card game according to claim 1 wherein the Club does not take part in the play of the game and has no interest in the result of the play.

3. The method of playing a card game according to claim 1 wherein no player plays against or makes a wager against the Club.
